(19) United States
(12) Patent Application Publication
(10) Pub. No.: US 2010/0194760 A1
(43) Pub. Date: Aug. 5, 2010

(54) Method and Apparatus Producing Text Patterning Data Correspondence To Image Data and Reconstructing Image Data Using the Text Patterning Data

(76) Inventor: Hak-soo Kim, Seongnam-si Gyeonggi-do (KR)

Correspondence Address: INTELLECTUAL PROPERTY LAW GROUP LLP, 12 SOUTH FIRST STREET, SUITE 1205, SAN JOSE, CA, 95113, US

(21) Appl. No.: 12/671,504

(22) PCT Filed: Jul. 23, 2008
(86) PCT No.: PCT/KR2008/004307

§ 371 Date: Jan. 29, 2010

(30) Foreign Application Priority Data
Aug. 1, 2007 (KR) 10-2007-0077386

(51) Int. Cl. G06T 11/00

(52) U.S. Cl. 345/467

(57) ABSTRACT

The present invention relates to a method and apparatus for generating text-pattern data corresponding to image data, and reconstructing image data using the generated text-pattern data. The present invention provides a method of generating text-pattern data corresponding to image data, comprising the steps of obtaining size information of image data; obtaining color value information, including color values used in all pixels constituting the image data; generating color value-corresponding text information by assigning different characters to respective color values included in the obtained color value information; generating a text string corresponding to the image data on a basis of the color value-corresponding text information; and generating text-pattern data, including the size information of the image data, the color value information, the color value-corresponding text information and the text string and method and apparatus for reconstruction image data using the text-pattern data.

### TECHNICAL FIELD

The present invention relates, in general, to a method and apparatus for generating text-pattern data corresponding to an image data and reconstructing the image data using the generated text-pattern data and more particularly, to a method and apparatus that generate text-pattern data, including the size information of image data, color value information, color value-corresponding text information and text string, and reconstruct image data by outputting colors corresponding to the text string using the generated text-pattern data.

### BACKGROUND ART

Recently, with the remarkable development and rapid popularization of communication technology, mobile communication terminals have been used across the whole nation. Among the functions of such a mobile communication terminal, the use of sending text messages, such as short messages (Short Message Service: SMS) and multimedia messages, has become widely used. Therefore, various types of communication-related additional services combined with such a message service have been proposed in various forms.

Such a communication-related additional service is not merely limited to the transmitting information, and its ability to provide interests and pleasures to a user also acts as an important factor. This is more important to the young generation who more frequently uses communication-related additional services. From this point of view, many service providers have recently developed various types of communication-related additional services that can be provided through a network. The types of currently commercialized additional services mainly related to multimedia messages to which an emoticon, a picture file, a flash file or a video file is attached. However, such a typical multimedia message is special in that it can transmit multimedia data, but is not very different from conventional message service in that the received message by a recipient is same as that of the message sent by a sender. Thus, multimedia message also has limitation in making special interests to users.

That is, there is a need to satisfy the various desires of users by providing new types of additional services using a sent message or sent data, rather than merely sending or receiving information, at the time of sending or receiving messages or data.

### DISCLOSURE

### Technical Problem

Accordingly, the present invention has been made keeping in mind the above limitations, and an object of the present invention is to provide a method and apparatus that obtain the size information of image data, color value information, color value-corresponding text information, and text string, generate text-pattern data including the obtained information, transmit the text-pattern data to a receiving client, and allow the receiving client to receive the text-pattern data and to reconstruct the text-pattern data into image data using the text string included in the text-pattern data, so that the user's interests are stimulated, thus a new type of method for sending message can be implemented.

Another object of the present invention is to provide a method and apparatus which can transmit messages or data in the form of a kind of game between a sending client and a receiving client, not merely sending the messages or data as a simple information, so that the practical use of additional services is increased by stimulating the user's pleasures and interests, and thus the method and apparatus can be utilized in various types of models which can create profit.

A further object of the present invention is to provide a method and apparatus which can transmit text pattern data of smaller size generated from image data of larger size, not sending the image data of larger size as it is in its raw form, thus reduce costs and time required for the transmitting message data.

### Technical Solution

In accordance with an aspect of the present invention to accomplish the above objects, there is provided a method of: generating text-pattern data corresponding to image data, comprising the steps of obtaining size information of image data; obtaining color value information, including color values used in all pixels constituting the image data; generating color value-corresponding text information by assigning different characters to respective color values included in the obtained color value information; generating a text string corresponding to the image data on a basis of the color value-corresponding text information; and generating text-pattern data, including the size information of the image data, the color value information, the color value-corresponding text information and the text string.

Preferably, the step of generating the text string corresponding to the image data on the basis of the color value-corresponding text information may be performed to generate the text string so that the text string is arranged depending on the size information of the image data.

In accordance with another aspect of the present invention, there is provided a method of reconstructing image data using a text-pattern data in an image data reconstruction apparatus, the text-pattern data generated by the method above and transmitted to the image data reconstruction apparatus, comprising the steps of: outputting a text string included in the text-pattern data to display means; and reconstructing image data by outputting colors having color values corresponding to respective characters to the display means with reference to color value-corresponding text information included in the text-pattern data, if data corresponding to the respective characters is input through input means with respect to the respective characters included in the output text string.

Preferably, the step of outputting the text string included in the text-pattern data to the display means may be performed to output colors so that the text string is arranged depending on size information of the image data included in the text-pattern data.

Further, the step of reconstructing image data by outputting colors having color values corresponding to respective characters to the display means with reference to color value-corresponding text information included in the text-pattern data, if data corresponding to the respective characters is input through input means with respect to the respective characters included in the output text string may be performed to output colors so that respective pixels of the image data are arranged depending on the size information of the image data, included in the text-pattern data.

Further, the image data reconstruction apparatus may be a mobile communication terminal for receiving the text-pattern data through a mobile communication network.

In accordance with another aspect of the present invention, there is provided an apparatus for generating text-pattern data corresponding to image data, comprising: an image data size information obtainment unit for obtaining size information of image data; a color value information obtainment unit for obtaining color value information, including color values used in all pixels constituting the image data; a color value-corresponding text information generation unit for generating color value-corresponding text information by assigning different characters to respective color values, included in the color value information obtained by the color value information obtainment unit; a text string generation unit for generating a text string corresponding to the image data on a basis of the color value-corresponding text information generated by the color value-corresponding text information generation unit; and a text-pattern data generation unit for generating text-pattern data, including the size information of the image data, the color value information, the color value-corresponding text information, and the text string.

Preferably, the text string generation unit may generate the text string so that the text string is arranged depending on the size information of the image data obtained by the image data size information obtainment unit.

In accordance with another aspect of the present invention, there is provided an apparatus for reconstructing image data, the apparatus receiving text-pattern data and reconstructing the image data, the text-pattern data including size information of the image data, color value information having color values used in all pixels constituting the image data, color value-corresponding text information indicating information about characters assigned to respective color values included in the color value information, and a text string corresponding to the image data generated based on the color value-corresponding text information, comprising: an image data reconstruction unit for outputting the text string included in the text-pattern data to display means, and reconstructing image data by outputting colors having color values corresponding to respective characters to the display means with reference to the color value-corresponding text information included in the text-pattern data, when data corresponding to the respective characters is input through input means with respect to respective characters included in the output text string.

Preferably, the image data reconstruction unit may reconstruct the image data by outputting colors so that respective pixels of the image data are arranged depending on the size information of the image data included in the text-pattern data.

Further, the image data reconstruction apparatus may be a mobile communication terminal for receiving the text-pattern data through a mobile communication network.

In accordance with another aspect of the present invention, there is provided a method of generating text-pattern data corresponding to image data, comprising the steps of: obtaining size information of image data; generating a text string corresponding to the image data by inquiring about characters corresponding to color values of respective pixels constituting the image data with reference to color value-corresponding text information, with respect to the respective pixels, the color value-corresponding text information being generated by assigning different characters to the respective color values in advance; and generating text-pattern data, including both size information of the image data and the text string.

Preferably, the step of generating the text string corresponding to the image data by inquiring about the characters corresponding to the color values of the respective pixels constituting the image data with reference to the color value-corresponding text information, with respect to the respective pixels, may be performed to generate the text string so that the text string is arranged depending on the size information of the image data.

In accordance with another aspect of the present invention, there is provided a method of reconstructing image data using a text-pattern data in an image data reconstruction apparatus having the color value-corresponding text information used in the method above, the text-pattern data generated by the method according to claim 12 or 13 and transmitted to the image data reconstruction apparatus, the method comprising the steps of: outputting a text string, included in the text-pattern data, to display means; and reconstructing image data by outputting colors having color values corresponding to respective characters included in the output text string to the display means with reference to the color value-corresponding text information when data corresponding to the respective characters is input through input means with respect to the respective characters included in the output text string.

Preferably, the step of outputting the text string included in the text-pattern data to the display means may be performed to output the text string so that the text string is arranged depending on size information of the image data included in the text-pattern data.

Further, the steps of reconstructing image data by outputting colors having color values corresponding to respective characters included in the output text string to the display means with reference to the color value-corresponding text information when data corresponding to the respective characters is input through input means with respect to the respective characters included in the output text string may be performed to output the colors so that respective pixels of image data are arranged depending on size information of the image data included in the text-pattern data.

Further, the image data reconstruction apparatus may be a mobile communication terminal for receiving the text-pattern data through a mobile communication network.

In accordance with another aspect of the present invention, there is provided an apparatus for generating text-pattern data corresponding to image data, comprising: an image data size information obtainment unit for obtaining size information of image data; a color value-corresponding text information storage unit for generating color value-corresponding text information by assigning different characters to respective color values, and for storing the color value-corresponding text information; a text string generation unit for generating a text string corresponding to the image data by inquiring about characters corresponding to color values of respective pixels constituting the image data with reference to the color value-corresponding text information stored in the color value-corresponding text information storage unit, with respect to respective pixels; and a text-pattern data generation unit for generating text-pattern data, including both the size information of the image data and the text string.

Preferably, the text string generation unit may generate the text string so that the text string is arranged depending on the size information of the image data obtained by the image data size information obtainment unit.

In accordance with another aspect of the present invention, there is provided an apparatus for reconstructing image data, the apparatus receiving text-pattern data and reconstructing the image data, the text-pattern data including both size information of the image data and a text string generated in correspondence with image data by inquiring about characters corresponding to color values of respective pixels of the image data with reference to color value-corresponding text information, the color value-corresponding text information being generated in advance by assigning different characters to respective color values, the apparatus comprising: a color value-corresponding text information storage unit for storing the color value-corresponding text information; and an image data reconstruction unit for outputting a text string included in the text-pattern data to display means, and reconstructing the image data by outputting colors having color values corresponding to respective characters to the display means with reference to the color value-corresponding text information stored in the color value-corresponding text information storage unit when data corresponding to respective characters included in the output text string is input through input means with respect to respective characters included in the output text string.

Preferably, the image data reconstruction unit may reconstruct the image data by outputting the colors so that respective pixels of the image data are arranged depending on the size information of the image data included in the text-pattern data.

Further, the image data reconstruction apparatus may be a mobile communication terminal for receiving the text-pattern data through a mobile communication network.

### ADVANTAGEOUS EFFECTS

Accordingly, the present invention can provide a method and apparatus that obtain the size information of image data, color value information, color value-corresponding text information and text string, generate text-pattern data including the generated information, transmit the text-pattern data to a receiving client, and allow the receiving client to receive the text-pattern data and to reconstruct the text-pattern data into image data using the text string included in the text-pattern data, so that the user's interests are stimulated, thus a new type of method for sending message can be implemented.

Further, the present invention can provide a method and apparatus which can transmit messages or data in the form of a kind of game between a sending client and a receiving client, not merely sending the messages or data as a simple information, so that the practical use of additional services is increased by stimulating the user's pleasures and interests, and thus the method and apparatus can be utilized in various types of models which can create profit.

Further, the present invention can provide a method and apparatus which can transmit text pattern data of smaller size generated from image data of larger size, not sending the image data of larger size as it is in its raw form, thus reduce costs and time required for the transmitting message data.

In addition, according to the present invention, a receiving user should complete image data by inputting character values and making colors corresponding to input character values displayed because the receiving client user who receives text-pattern data cannot intuitively ascertain which type of image data is received, so that the user's curiosity can be stimulated and the user's pleasure can be increased during a procedure for completing the image data, thus improving the favorable impression and practical use.

### DESCRIPTION OF DRAWINGS

FIG. 1 is a configuration diagram showing the connection of an entire system for implementing a method of generating text-pattern data corresponding to image data and reconstructing image data using the text-pattern data according to the present invention;

FIG. 2 is a block diagram showing the detailed construction of the text-pattern data generation apparatus 30 of FIG. 1;

FIG. 3 is a flowchart showing an embodiment of a method of generating text-pattern data corresponding to image data, the method being performed by the text-pattern data generation apparatus 30 of the present invention;

FIG. 4 is a flowchart showing an embodiment of a method of reconstructing image data using received text-pattern data in a receiving client, which receives the text-pattern data, according to the present invention;

FIG. 5 is a diagram showing an example of text-pattern data used in an embodiment of the present invention;

FIGS. 6 and 7 are diagrams showing examples of the generation of actual text-pattern data according to the present invention;

FIG. 8 is a diagram showing an example of a process for reconstructing image data using text-pattern data in a receiving client;

FIG. 9 is a block diagram showing the detailed construction of a text-pattern data generation apparatus 30′ according to another embodiment of the present invention;

FIG. 10 is a flowchart showing a process for generating text-pattern data, the process being performed by the text-pattern data generation apparatus 30′ of FIG. 9; and

FIG. 11 is a diagram showing an example of text-pattern data used in embodiments of FIGS. 9 and 10.

### BEST MODE FOR CARRYING OUT THE INVENTION

Hereinafter, embodiments of the present invention will be described in detail with reference to the attached drawings.

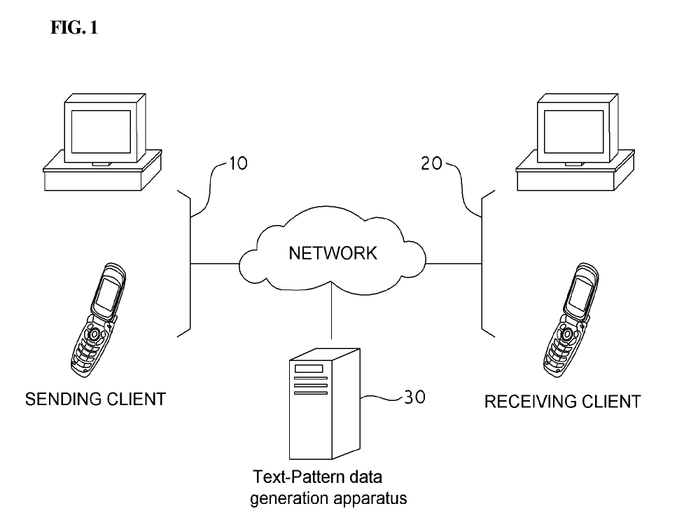

FIG. 1 is a configuration diagram showing the connection of an entire system for implementing a method of generating text-pattern data corresponding to image data and reconstructing image data using the text-pattern data according to the present invention.

Referring to FIG. 1, an apparatus 30 for generating text-pattern data corresponding to image data according to the present invention (hereinafter referred to as a ‘text-pattern data generation apparatus’) is connected both to a sending client 10 and to a receiving client 20 through a network.

The text-pattern data generation apparatus 30 generates text-pattern data corresponding to its own image data, and transmits the text-pattern data to the receiving client 20. The receiving client reconstructs image data corresponding to a text string, included in the received text-pattern data, using the text-pattern data, and outputs the reconstructed image data. Here, the term ‘text-pattern data’ means data obtained by patterning image data in the form of text, and the term ‘text string’ means the array of characters, which corresponds to the image data and is generated by patterning the image data in the form of text, as described above. A detailed meaning of the text-pattern data and the text string and a method of generating them will be described later.

The sending client 10 may be, for example, a computer, a Personal Digital Assistant (PDA) or a mobile communication terminal capable of accessing the text-pattern data generation apparatus 30 through the network, and is configured to access the text-pattern data generation apparatus 30, select image data intended to be sent, select a receiving client 20, which will receive text-pattern data generated in correspondence with the selected image data, and transmit the text-pattern data to the receiving client 20.

The receiving client 20 is connected to the text-pattern data generation apparatus 30 through the network, and is configured to receive the text-pattern data generated by the text-pattern data generation apparatus 30, reconstruct a text string included in the received text-pattern data into image data with reference to the text-pattern data, and output the reconstructed image data. The receiving client 20 may also be a computer, a PDA or a mobile communication terminal.

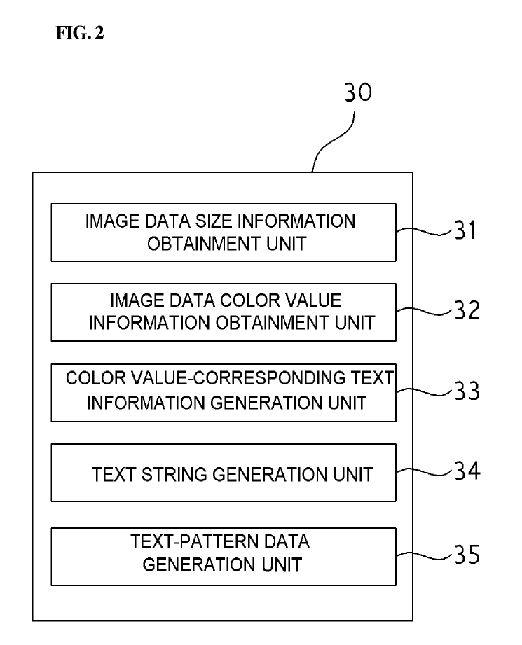

FIG. 2 is a block diagram showing the detailed construction of the text-pattern data generation apparatus 30 of FIG. 1.

Referring to FIG. 2, the text-pattern data generation apparatus 30 includes an image data size information obtainment unit 31, an image data color value information obtainment unit 32, a color value-corresponding text information generation unit 33, a text string generation unit 34, and a text-pattern data generation unit 35.

When image data, which is target data to be patterned, is set by the text-pattern data generation apparatus 30, the image data size information obtainment unit 31 detects the size information of the set image data, for example, the number of horizontal pixels and the number of vertical pixels of the image data, thus obtaining the size information of the image data. The obtained size information is used when the text string generation unit 34 and the text-pattern data generation unit 35, which will be described later, generate a text string and text-pattern data, respectively.

When image data, which is target data to be patterned, is set by the text-pattern data generation apparatus 30, the image data color value information obtainment unit 32 functions to detect the color value information of the set image data. That is, the types and numbers of color values used in all pixels constituting the image data are detected. In detail, the number of color values used in all pixels constituting the image data is detected, and colors indicated by detected color values are detected. The detection of color values can be performed depending on values indicated by, for example, R, G and B values.

The color value-corresponding text information generation unit 33 functions to assign different characters to respective color values on the basis of the color value information obtained by the image data color value information obtainment unit 32. For example, when color values detected by the image data color value information obtainment unit 32 are white, black, red, and blue, different characters are assigned to respective color values in such a way that white=A, black=B, red=C, and blue=D, and thus text information about characters corresponding to all color values used in the image data is generated.

The text string generation unit 34 functions to generate a text string corresponding to image data on the basis of the color value-corresponding text information generated by the color value-corresponding text information generation unit 33. In this case, arrays of the text string can be set using the size information of the image data detected by the image data size information obtainment unit 31. That is, the text string is generated while characters corresponding to all the pixels of the image data are arranged on the basis of the color value-corresponding text information generated by the color value-corresponding text information generation unit 33. At this time, the horizontal and vertical arrays of the text string can be defined depending on the size information previously obtained by the image data size information obtainment unit 31, that is, information about the number of horizontal pixels and the number of vertical pixels of the image data. Of course, it is also possible to implement the text string in the form of a simple one-dimensional text array rather than horizontal and vertical arrays without referring to the size information.

The text-pattern data generation unit 35 generates text-pattern data, including the image data size information, the color value information, the color value-corresponding text information, and the text string, which are generated through the above process. As described above, the text-pattern data generated by the text-pattern data generation unit 35 is data obtained by patterning the information to be required to reconstruct image data as text data. Accordingly, when such data is transmitted to the receiving client 20, the receiving client 20 can reconstruct image data by the text-pattern data.

Meanwhile, in addition to the above-described components, the text-pattern data generation apparatus 30 includes components for connection with the network, the sending client 10, and the receiving client 20 and for data transmission/reception, but these components are well known to those skilled in the art, and thus a detailed description thereof is omitted.

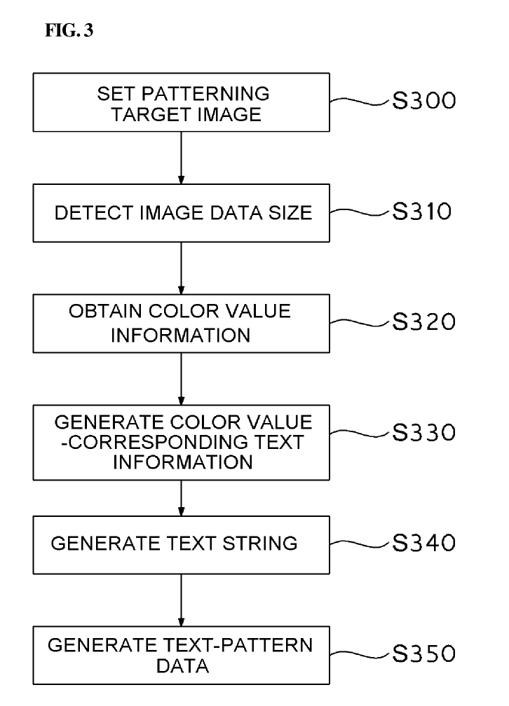

FIG. 3 is a flowchart showing an embodiment of a method of generating text-pattern data corresponding to image data, the method being performed by the text-pattern data generation apparatus 30 of the present invention.

Referring to FIG. 3, image data, which is target data for the generation of text-pattern data, is set at step S300. As described above with reference to FIG. 1, the setting of image data can be performed using a method in which the sending client 10 accesses the text-pattern data generation apparatus 30, checks, for example, an image data list, and selects one from the image data list.

When the image data, which is the target data to be patterned, is set, the text-pattern data generation apparatus 30 primarily detects the size information of the image data at step S310. As described above, the size information may be information about the number of horizontal and vertical pixels of the image data, etc.

When the size information is detected, color value information about color values used in all of the pixels constituting the image data is obtained at step S320. The obtainment of the color value information is performed by obtaining information about the types and numbers of color values used in all the pixels of the image data, as described above.

Next, color value-corresponding text information is generated by assigning different character values to respective colors used in all the pixels of the image data at step S330. As described above, the generated color value-corresponding text information refers to corresponding information in which different character values are assigned to respective colors used in the image data.

After the color value-corresponding text information is generated, a text string corresponding to the image data is generated using the color value-corresponding text information at step S340. As described above, the generation of the text string is performed by obtaining character values corresponding to the color values of respective pixels of the image data with reference to the color value-corresponding text information, and arranging the obtained character values.

Finally, text-pattern data, including the image data size information, the color value information, the color value-corresponding text information and the text string, which are generated through the above process, is generated at step S350.

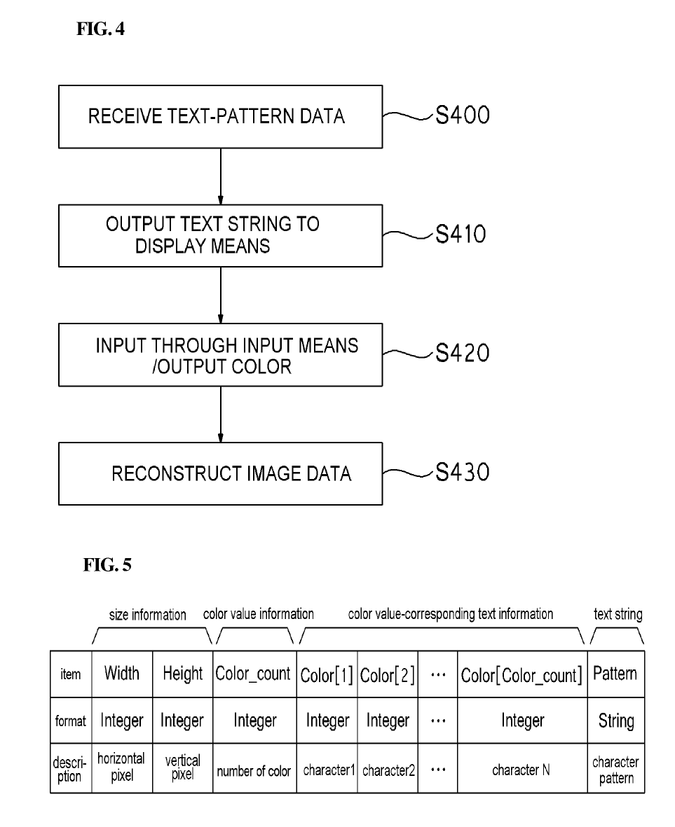

FIG. 4 is a flowchart showing an embodiment of a method of reconstructing image data using received text-pattern data in a receiving client, which receives the text-pattern data, according to the present invention.

Referring to FIG. 4, first, the receiving client receives the text-pattern data from the text-pattern data generation apparatus 30 at step S400, and outputs a text string, included in the received text-pattern data, to the display means of the receiving client at step S410.

When data corresponding to respective characters ranging from the first character to the last character included in the output text string is input through an input means while sequentially moving a cursor along the respective characters after the text string has been output to the display means of the receiving client, colors having color values corresponding to respective characters are output to the display means of the receiving client with reference to the color value-corresponding text information included in the text-pattern data at step S420. When the receiving client is, for example, a computer or a mobile communication terminal, such a process may be performed by repeating a procedure for outputting the text string to a display means, such as an LCD or the like, locating the cursor at the first character of the text string, determining whether the relevant character has been input, outputting a color having a color value corresponding to the character if it is determined that the character has been input, and moving the cursor to the next character.

Of course, the movement of the cursor can be designated in such a way that the cursor is sequentially moved, for example, in a direction from an upper left portion to a lower right portion, or in such a way that the cursor is moved following the user's free movements created by using a direction key or the like of the input means of the receiving client.

Meanwhile, the outputting of colors having color values corresponding to respective characters may be performed by configuring a screen separate from a text string, which has been previously output to the display means, that is, a screen to which image data is to be output, and outputting respective colors to the separate screen, thus enabling the image data to be sequentially completed. Alternatively, a corresponding color may be output to the location of each given character on the screen to which the text string is output. Further, the two methods can be used together.

Through the above process, when the characters leading to the last character have been completely input, image data corresponding to the text-pattern data can be reconstructed and can be output to the display means at step S430.

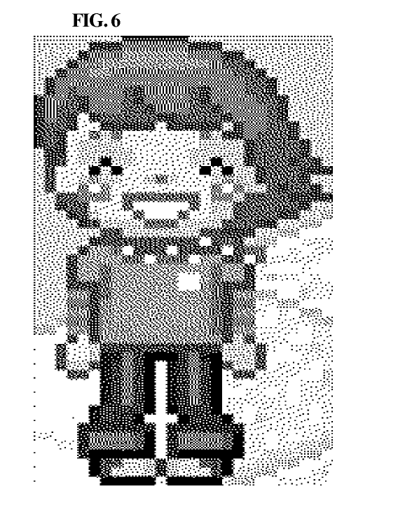

FIG. 5 is a diagram showing an example of text-pattern data used in an embodiment of the present invention.

Referring to FIG. 5, the text-pattern data may be configured to include the size information, the color value information, the color value-corresponding text information and the text string, as described above.

The size information is information about the size of the image data and may be information, such as the number of horizontal pixels and the number of vertical pixels of the image data, as shown in the drawing. The color value information is information indicating the number of all colors used in all the pixels of the image data, and color value-corresponding text information is information obtained by causing different characters to correspond to respective colors from among all of the colors used in the image data. The text string is information obtained by sequentially arranging characters corresponding to the colors of respective pixels of the image data, with respect to all of the pixels of the image data.

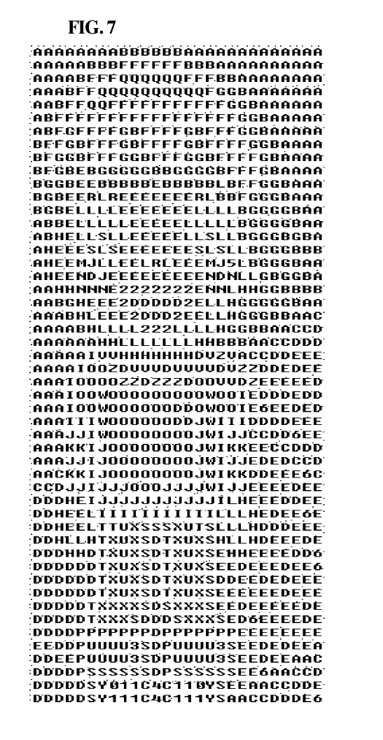

FIGS. 6 and 7 are diagrams showing examples in which actual text-pattern data is generated according to the present invention, wherein FIG. 6 illustrates image data, and FIG. 7 illustrates a text string included in text-pattern data corresponding to the image data of FIG. 6.

After the image data size information, the color value information, and the color value-corresponding text information of FIG. 6 have been obtained, a text string formed through the above-described process using the obtained information appears in the shape of FIG. 7. It can be seen that the text string of FIG. 7 is formed in a two-dimensional array in which characters are horizontally and vertically arranged according to the size of the image data of FIG. 6.

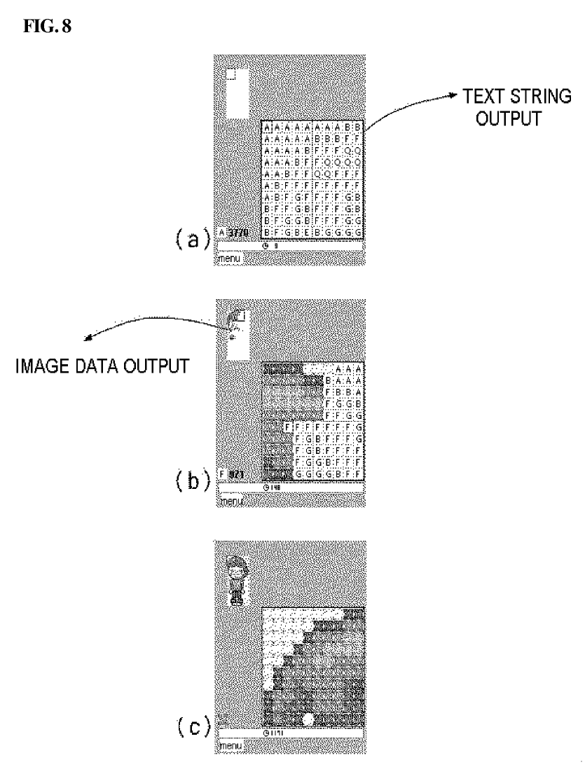

FIG. 8 is a diagram showing an example of a process for reconstructing image data using text-pattern data in a receiving client.

Referring to FIG. 8, when receiving the text-pattern data, the receiving client makes a text string, included in the text-pattern data, output to a display means. Thereafter, when input values corresponding to respective characters are input through an input means, such as a keypad or the like, while sequentially moving the cursor from the first character to the last character of the text string, as described above, the receiving client checks colors having color values corresponding to respective characters with reference to the color value-corresponding text information included in the text-pattern data, and then makes the colors output to the display means.

FIG. 8 shows such a process sequentially, wherein FIG. 8(a) illustrates the state in which a text string is initially output to a lower right portion of the display means, and FIG. 8(b) illustrates the state in which some portions of the text string are converted into colors corresponding to respective characters and are then output. In an upper left portion of FIG. 8(b), a separate screen on which the entire image data is output may be configured. FIG. 8 (c) illustrates the state in which the outputting of colors corresponding to respective characters has been completed.

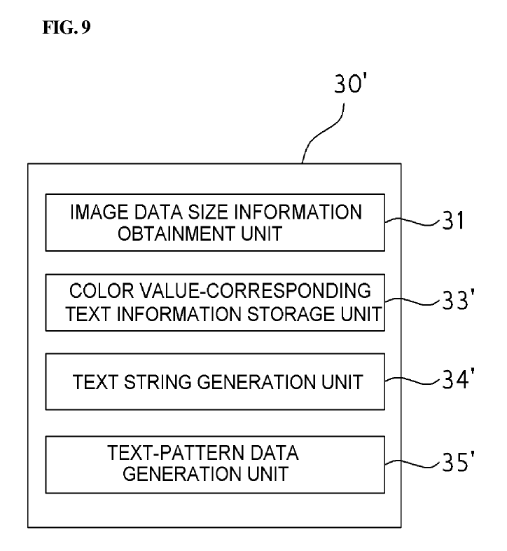

FIG. 9 is a block diagram showing the detailed construction of a text-pattern data generation apparatus 30′ according to another embodiment of the present invention.

Compared to the text-pattern data generation apparatus 30 of FIG. 2, the text-pattern data generation apparatus 30′ of FIG. 9 has a difference in that color value-corresponding text information is generated in advance, and only a text string and the size information of image data are generated at the time of generating text-pattern data.

Referring to FIG. 9, the text-pattern data generation apparatus 30′ includes an image data size information obtainment unit 31, a color value-corresponding text information storage unit 33′, a text string generation unit 34′, and a text-pattern data generation unit 35′.

The image data size information obtainment unit 31 has the same construction and operation as the image data size information obtainment unit 31 of FIG. 2, and thus a detailed description thereof is omitted.

The color value-corresponding text information storage unit 33′ stores color value-corresponding text information generated by assigning different characters to respective color values. Here, the color value-corresponding text information is similar to that described with reference to FIG. 2, but there is a difference in that different characters are unalterably assigned to respective colors in advance, without being assigned to respective color values for each piece of image data. For example, in FIG. 2, one of A, B and C can be assigned to a red color for each piece of image data. However, in FIG. 9, one character is assigned to a red color.

The text string generation unit 34′ functions to generate a text string corresponding to image data with reference to the color value-corresponding text information storage unit 33′. That is, the text string generation unit 34′ inquires characters, corresponding to the color values of respective pixels of the image data, from the color value-corresponding text information storage unit 33′ with respect to the respective pixels, thus generating a text string based on the arrays of characters corresponding to the pixels. The text string generation unit 34′ of FIG. 9 is different from the text string generation unit 34 of FIG. 2, which uses different pieces of color value-corresponding text information for respective pieces of image data, in that unalterable color value-corresponding text information, stored in the color value-corresponding text information storage unit 33′, is used. Other constructions and operations of the text string generation unit 34′ are the same as those of FIG. 2, and thus a detailed description thereof is omitted.

The text-pattern data generation unit 35′ generates text-pattern data, including the image data size information and the text string, which are generated through the above process. Compared to the text-pattern data generation unit 35 of FIG. 2, the text-pattern data generation unit 35′ has a difference only in the type of data included in the generated text-pattern data. That is, the text-pattern data generation unit 35′ of FIG. 9 includes neither color value information nor color value-corresponding text information. The reason for this is that the text-pattern data generation apparatus 30′ of FIG. 9 uses the unalterable color value-corresponding text information, which is uniformly used for all image data, as described above. Due thereto, the receiving client 20, which will be described later, must apparently use the same color value-corresponding text information. Compared to the case of FIG. 2, the text-pattern data generation apparatus 30′ of FIG. 9 can be configured to reduce the number of types of text-pattern data, so that the number of types and size of data can be reduced, and thus there is an advantage in that the time required for the generation of data and the transmission of data, and network load can be reduced.

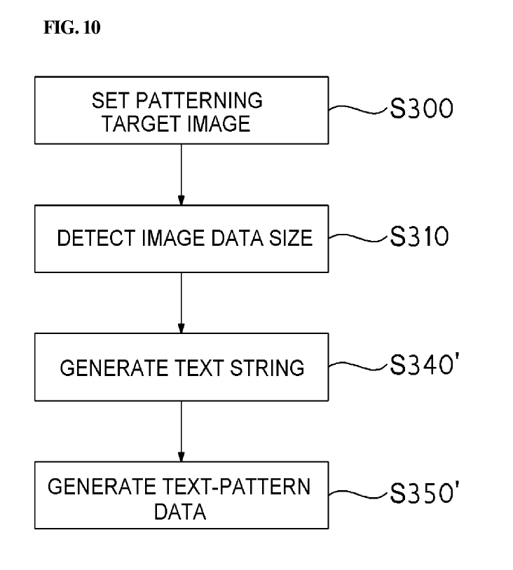

FIG. 10 is a flowchart showing a process for generating text-pattern data, the process being performed by the text-pattern data generation apparatus 30′ of FIG. 9.

Referring to FIG. 10, image data, which is target data for the generation of text-pattern data, is set at step S300, and the size information of the set image data is detected at step S310. Steps S300 and S310 are the same as those of FIG. 2, and thus a detailed description thereof is omitted.

Next, a text string corresponding to the image data is generated at step S340′. The generation of the text string at step S340′ is the same as that of the cases of FIGS. 2 and 3 in that, as described above with reference to FIG. 9, the text string is generated by obtaining character values corresponding to the color values of respective pixels of the image data with reference to color value-corresponding text information, and arranging the obtained character values, but there is a difference in that the text string is generated with reference to the color value-corresponding text information, in which characters corresponding to respective color values are unalterably generated in advance, in order to allow the color value-corresponding text information to be used uniformly for all image data.

Next, text-pattern data, including the generated image data size information and the generated text string, is generated at step S350′.

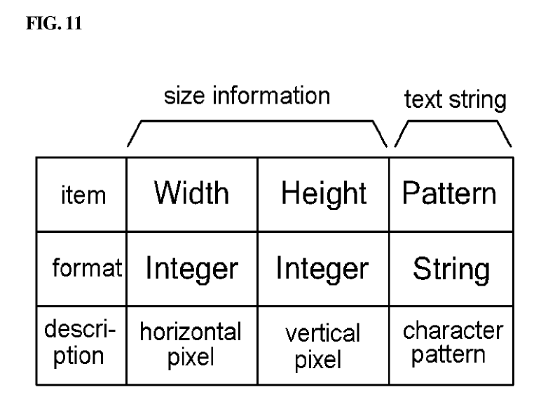

FIG. 11 is a diagram showing an example of text-pattern data used in embodiments of FIGS. 9 and 10.

Referring to FIG. 11, the text-pattern data has the same configuration as that of FIG. 5, except that it includes only the size information and the text string, and thus a detailed description of repeated configuration is omitted. Compared to the text-pattern data of FIG. 5, the text-pattern data of FIG. 11 has data, the number of types of which is much smaller than that of the text-pattern data of FIG. 5, so that the size of data is reduced, thus remarkably decreasing the time required for the generation and transmission of data. The reason for this is that the text-pattern data of FIG. 11 uses color value-corresponding text information, which is used uniformly for all image data, without employing a scheme for generating different pieces of color value-corresponding text information for respective pieces of image data and for generating the text string with reference to the color value-corresponding text information, as described above, and thus it is possible to omit both color value information and color value-corresponding text information.

Meanwhile, the receiving client, which reconstructs image data using the text-pattern data generated in the embodiments described with reference to FIGS. 9 to 11, must apparently have the same information as the color value-corresponding text information used in the text-pattern data generation apparatus 30′ of FIG. 9. In the text-pattern data generated in the embodiments of FIGS. 9 to 11, since information indicating which color values correspond to respective characters (color value information and color value-corresponding text information) is omitted, the receiving client makes the image data, corresponding to the text string included in the text-pattern data, output to the display means of the receiving client using the method of FIG. 4, with reference to the color value-corresponding text information stored in the receiving client.

Meanwhile, in the above-described embodiments of the present invention, the receiving client may be a mobile communication terminal. Here, the receiving client receives the text-pattern data through a mobile communication network. The transmission of the text-pattern data may be performed using a data transmitting method based on the Internet or the like, or a data transmitting method based on a short message service or a multimedia message service. However, in the present invention, a method of transmitting data is not especially limited to a specific method, and thus the present invention can be applied without change, regardless of which one of the above methods is used.

Further, when the receiving client reconstructs image data, it is possible to run a dedicated program for performing reconstruction, and read text-pattern data through the program, thus enabling the image data to be reconstructed. At this time, the dedicated program may be implemented by a game program.

In this case, the text-pattern data will function as game data required to execute the game program. When text-pattern data is received, the present invention may be configured to further include a process for determining whether the dedicated program has been installed in the receiving client, providing a guidance message for prompting the dedicated program to be installed to a receiving client user if it is determined that no dedicated program is installed, accessing a server for storing the dedicated program, and receiving the program.

Although the preferred embodiments of the present invention have been disclosed for illustrative purposes, those skilled in the art will appreciate that the present invention is not limited to the above embodiments, and various modifications, additions and substitutions are possible, without departing from the scope and spirit of the invention as disclosed in the accompanying claims.

I claim:

1. A method of generating text-pattern data corresponding to image data, comprising the steps of:
obtaining size information of image data;
obtaining color value information, including color values used in all pixels constituting the image data;
generating color value-corresponding text information by assigning different characters to respective color values included in the obtained color value information;
generating a text string corresponding to the image data on a basis of the color value-corresponding text information; and
generating text-pattern data, including the size information of the image data, the color value information, the color value-corresponding text information and the text string.

2. The method according to claim 1, wherein the step of generating the text string corresponding to the image data on the basis of the color value-corresponding text information is performed to generate the text string so that the text string is arranged depending on the size information of the image data.

3. A method of reconstructing image data using a text-pattern data in an image data reconstruction apparatus, the text-pattern data generated by the method according to claim 1 or 2 and transmitted to the image data reconstruction apparatus, comprising the steps of:
outputting a text string included in the text-pattern data to display means; and
reconstructing image data by outputting colors having color values corresponding to respective characters to the display means with reference to color value-corresponding text information included in the text-pattern data, if data corresponding to the respective characters is input through input means with respect to the respective characters included in the output text string.

4. The method according to claim 3, wherein the step of outputting the text string included in the text-pattern data to the display means is performed to output colors so that the text string is arranged depending on size information of the image data included in the text-pattern data.

5. The method according to claim 3, wherein, the step of reconstructing image data by outputting colors having color values corresponding to respective characters to the display means with reference to color value-corresponding text information included in the text-pattern data, if data corresponding to the respective characters is input through input means with respect to the respective characters included in the output text string is performed to output colors so that respective pixels of the image data are arranged depending on the size information of the image data, included in the text-pattern data.

6. The method according to claim 3, wherein the image data reconstruction apparatus is a mobile communication terminal for receiving the text-pattern data through a mobile communication network.

7. An apparatus for generating text-pattern data corresponding to image data, comprising:
an image data size information obtainment unit for obtaining size information of image data;
a color value information obtainment unit for obtaining color value information, including color values used in all pixels constituting the image data;
a color value-corresponding text information generation unit for generating color value-corresponding text information by assigning different characters to respective color values, included in the color value information obtained by the color value information obtainment unit;
a text string generation unit for generating a text string corresponding to the image data on a basis of the color value-corresponding text information generated by the color value-corresponding text information generation unit; and
a text-pattern data generation unit for generating text-pattern data, including the size information of the image data, the color value information, the color value-corresponding text information, and the text string.

8. The apparatus according to claim 7, wherein the text string generation unit generates the text string so that the text string is arranged depending on the size information of the image data obtained by the image data size information obtainment unit.

9. An apparatus for reconstructing image data, the apparatus receiving text-pattern data and reconstructing the image data, the text-pattern data including size information of the image data, color value information having color values used in all pixels constituting the image data, color value-corresponding text information indicating information about characters assigned to respective color values included in the color value information, and a text string corresponding to the image data generated based on the color value-corresponding text information, comprising:
an image data reconstruction unit for outputting the text string included in the text-pattern data to display means, and reconstructing image data by outputting colors having color values corresponding to respective characters to the display means with reference to the color value-corresponding text information included in the text-pattern data, when data corresponding to the respective characters is input through input means with respect to respective characters included in the output text string.

10. The apparatus according to claim 9, wherein the image data reconstruction unit reconstructs the image data by outputting colors so that respective pixels of the image data are arranged depending on the size information of the image data included in the text-pattern data.

11. The apparatus according to claim 9, wherein the image data reconstruction apparatus is a mobile communication terminal for receiving the text-pattern data through a mobile communication network.

12. A method of generating text-pattern data corresponding to image data, comprising the steps of:
obtaining size information of image data;
generating a text string corresponding to the image data by inquiring about characters corresponding to color values of respective pixels constituting the image data with reference to color value-corresponding text information, with respect to the respective pixels, the color value-corresponding text information being generated by assigning different characters to the respective color values in advance; and
generating text-pattern data, including both size information of the image data and the text string.

13. The method according to claim 12, wherein the step of generating the text string corresponding to the image data by inquiring about the characters corresponding to the color values of the respective pixels constituting the image data with reference to the color value-corresponding text information, with respect to the respective pixels, is performed to generate the text string so that the text string is arranged depending on the size information of the image data.

14. A method of reconstructing image data using a text-pattern data in an image data reconstruction apparatus having the color value-corresponding text information used in the method according to claim 12 or 13, the text-pattern data generated by the method according to claim 12 or 13 and transmitted to the image data reconstruction apparatus, the method comprising the steps of:
outputting a text string, included in the text-pattern data, to display means; and
reconstructing image data by outputting colors having color values corresponding to respective characters included in the output text string to the display means with reference to the color value-corresponding text information when data corresponding to the respective characters is input through input means with respect to the respective characters included in the output text string.

15. The method according to claim 14, wherein the step of outputting the text string included in the text-pattern data to the display means is performed to output the text string so that the text string is arranged depending on size information of the image data included in the text-pattern data.

16. The method according to claim 14, wherein, the steps of reconstructing image data by outputting colors having color values corresponding to respective characters included in the output text string to the display means with reference to the color value-corresponding text information when data corresponding to the respective characters is input through input means with respect to the respective characters included in the output text string is performed to output the colors so that respective pixels of image data are arranged depending on size information of the image data included in the text-pattern data.

17. The method according to claim 14, wherein the image data reconstruction apparatus is a mobile communication terminal for receiving the text-pattern data through a mobile communication network.

18. An apparatus for generating text-pattern data corresponding to image data, comprising:
an image data size information obtainment unit for obtaining size information of image data;
a color value-corresponding text information storage unit for generating color value-corresponding text information by assigning different characters to respective color values, and for storing the color value-corresponding text information;
a text string generation unit for generating a text string corresponding to the image data by inquiring about characters corresponding to color values of respective pixels constituting the image data with reference to the color value-corresponding text information stored in the color value-corresponding text information storage unit, with respect to respective pixels; and
a text-pattern data generation unit for generating text-pattern data, including both the size information of the image data and the text string.

19. The apparatus according to claim 18, wherein the text string generation unit generates the text string so that the text string is arranged depending on the size information of the image data obtained by the image data size information obtainment unit.

20. An apparatus for reconstructing image data, the apparatus receiving text-pattern data and reconstructing the image data, the text-pattern data including both size information of the image data and a text string generated in correspondence with image data by inquiring about characters corresponding to color values of respective pixels of the image data with reference to color value-corresponding text information, the color value-corresponding text information being generated in advance by assigning different characters to respective color values, the apparatus comprising:
a color value-corresponding text information storage unit for storing the color value-corresponding text information; and
an image data reconstruction unit for outputting a text string included in the text-pattern data to display means, and reconstructing the image data by outputting colors having color values corresponding to respective characters to the display means with reference to the color value-corresponding text information stored in the color value-corresponding text information storage unit when data corresponding to respective characters included in the output text string is input through input means with respect to respective characters included in the output text string.

21. The apparatus according to claim 20, wherein the image data reconstruction unit reconstructs the image data by outputting the colors so that respective pixels of the image data are arranged depending on the size information of the image data included in the text-pattern data.

22. The apparatus according to claim 20, wherein the image data reconstruction apparatus is a mobile communication terminal for receiving the text-pattern data through a mobile communication network.
